(19) United States
(12) Patent Application Publication
(10) Pub. No.: US 2016/0043585 A1
(43) Pub. Date: Feb. 11, 2016

(54) Rapid Charging Mobile Electronic Device Battery Case

(71) Applicants: Michael Jozef Zawadzki, Park Ridge, IL (US); Krzysztof Ziemkiewicz, East Taunton, MA (US); Michael John Majchrzak, JR., Homewood, IL (US)

(72) Inventors: Michael Jozef Zawadzki, Park Ridge, IL (US); Krzysztof Ziemkiewicz, East Taunton, MA (US); Michael John Majchrzak, JR., Homewood, IL (US)

(21) Appl. No.: 14/524,652

(22) Filed: Oct. 27, 2014

Related U.S. Application Data
(60) Provisional application No. 62/033,514, filed on Aug. 5, 2014.

(51) Int. Cl. H02J 7/00

(52) U.S. Cl. CPC H02J 7/0044

(57) ABSTRACT

A rapid charging battery case for a mobile electronic device that comprises a protective casing, a fast charging battery, and a charging circuit. The protective casing forms a snug fit between the casing and the mobile electronic device protecting the mobile electronic device from impact forces. The battery case includes a power jack input port for receiving a 3.5 mm diameter power supply jack that charges the fast charging battery in under fifteen minutes. The internal battery of the mobile electronic device is charged simultaneously with the fast charging battery. Once the power supply is disconnected from the battery case, the fast charging battery continues to charge the internal battery of the mobile electronic device.

This application claims priority to provisional application Ser. No. 62/033,514 filed Aug. 5, 2014, to the extent allowed by law.

### BACKGROUND OF THE INVENTION

1. Field of the Invention

The present invention relates to battery cases for mobile electronic devices, and more particularly, to a battery case for mobile electronic devices that charges the battery in the case electrically connected to a mobile electronic device in less than fifteen minutes.

2. Description of the Prior Art

Modern society has become increasingly dependent on mobile electronic devices, including smart phones. Mobile electronic devices generally rely on batteries to deliver the power they need to operate. As the battery is depleted, it must be recharged. The four most common methods of recharging are: overnight charging, which is slow charging, does not disrupt use, and typically yields a full recharge; in-car charging, which is slow charging, does not disrupt use, and does not usually yield a full charge except on long trips; USB charging, which is very slow charging, typically requiring over 1.5 hours, but practical if sitting by a computer for longer periods; and wall socket charging, which is slow charging, keeps the mobile electronic device stuck to the wall for an extended period of time, and usually disrupts the use of the mobile electronic device.

Many types of mobile electronic device battery cases, and methods used to power and recharge the mobile battery cases, have come on the market in an effort to prolong the battery life of the mobile electronic device. Current smart phone battery cases extend the time between charges of the smart phone and battery case batteries, thereby reducing the frequency of charges, requiring both the smart phone and battery case battery to charge. This doubles the charge time and extends the time between charges, but does not reduce the charge time itself, and use simple lithium batteries with unsophisticated charging circuits.

U.S. Patent Publication 2013/0314030 discloses a battery case for a mobile device that includes a case, electrical components, a port, and an aperture size to contain at least one rechargeable battery. The battery case disclosed in publication '030 provides a charger including a mount to receive a rechargeable battery. The rechargeable battery may be configured to fit inside the battery case.

U.S. Pat. No. 8,531,833 discloses a portable electronic device case with a battery that protects and extends the battery life of the electronic device. The case has a lower case portion and an upper case portion, which assemble together to protect the top, side, and bottom edges of the electronic device. The lower case portion includes the battery.

The present invention involves a new mode of mobile electronic device battery case charging that seeks to change the old slow charging battery case paradigm, which takes one to three hours to fully charge the internal battery of a mobile electronic device, by charging the battery case rapid charge battery in under fifteen minutes, typically in eight to ten minutes. The user is able to keep using their mobile electronic device battery case throughout the day with only minutes of downtime required to provide a full or partial recharge, as the battery case will only require approximately one minute of charge for each hour of usage time for a 1500 mAh or greater battery. In particular, the battery case of the present invention achieves the rapid charging time without affecting the utility of the mobile device in terms of the ability to carry the mobile electronic device and battery case as it was intended such that the weight and dimensions do not differ significantly from current mobile electronic device battery case designs. Furthermore, the power supply that charges the battery case in the present invention does not differ significantly in size or weight from the three main original mobile electronic device battery case power supplies: a standard 12V cigarette lighter power supply in the form of a single cable extending from the cigarette lighter receptacle in the automobile to the battery case without a transformer; a typical laptop power supply; and the original mobile electronic device power supply provided with the mobile electronic device that can be used to charge the battery case and the mobile electronic device.

A primary object of the present invention is to provide a rapid charging mobile electronic device battery case that provides the battery case battery with a full charge in less than fifteen minutes, thereby providing the internal battery of a mobile electronic device with a source of energy in less than fifteen minutes.

It is another object of the present invention to provide a rapid charging mobile electronic device battery case that allows the user to keep using their mobile electronic device battery case throughout the day, requiring approximately one minute of charge for each hour of usage time for a 1500 mAh, or greater, battery.

It is yet another object of the present invention to provide a rapid charging mobile electronic device battery case that has dimensions and a weight that does not significantly differ from current mobile electronic device battery cases.

It is yet another object of the present invention to provide a rapid charging mobile electronic device battery case that uses a power supply that does not differ significantly in size or weight from the three main original mobile electronic device battery case power supplies (a standard 12V cigarette lighter power supply, a typical USB computer power supply, and the original mobile electronic device power supply provided with the mobile electronic device).

It is yet another object of the present invention to provide a rapid charging mobile electronic device battery case that shortens the time it takes to recharge the battery in the mobile electronic device battery case to mere minutes while not sacrificing any of the current size, shape, and weight advantages of the current mobile electronic device battery cases and their associated power supplies.

It is yet another object of the present invention to provide a rapid charging mobile electronic device battery case allowing rapid recharging and use of the battery in the case with reduced heating under higher power demand conditions.

It is yet another object of the present invention to provide a rapid charging mobile electronic device battery case that is designed so that the bottom speaker ports of the mobile electronic device are not obstructed.

### SUMMARY OF THE INVENTION

A rapid charging battery case for a mobile electronic device that comprises a protective casing, a fast charging (FC) battery, and a charging circuit. The protective casing includes an aperture for the electronic screen display of the mobile electronic device and has internal dimensions substantially the same as the external dimensions of the mobile electronic device, forming a snug fit between the casing and the mobile electronic device. In one embodiment, the protective casing includes an elliptical bottom that distributes impact forces and protects the mobile electronic device upon impact.

The battery case includes a power jack input port for receiving an external 3.5 mm diameter power supply jack, for example. The power is converted to a lower voltage within the charging circuit to charge the FC battery when the FC battery has been discharged below a safe level. Once the FC battery obtains a safe level of charge, the power is converted to a higher voltage to continue charging the FC battery. When the FC battery reaches a voltage of 4.2V the power is again converted to a lower voltage to avoid overcharging.

When the mobile electronic device is in the battery case and the FC battery has a charge level above zero, the battery case will charge the internal battery of the mobile electronic device and the charging indicator on the mobile electronic device will show that the device is in charging mode. When the power supply jack is placed into the battery case, the fast charging battery will start to charge. The power supply charges the FC battery simultaneously with the internal battery of the mobile electronic device. The mobile electronic device will not take power directly from the power supply jack, but will take the power it is able to take from the power supply jack via the control circuitry of the power management microprocessor in order to ensure the proper voltage is provided to the DC/DC converter before charging the internal battery of the mobile electronic device.

While the power supply jack is still in the battery case, the internal battery of the mobile electronic device and the FC battery will receive power from the power supply jack simultaneously. When the FC battery reaches full charge, the power from the power supply jack to the FC battery and to the internal battery of the mobile electronic device will be electronically shut off by a power management and charge controller, such as the LTC4020 buck-boost multi-chemistry battery charger, and then the FC battery will begin charging the internal battery of the mobile electronic device directly. When the charge level of the FC battery discharges into the internal battery of the mobile electronic device and reaches a certain pre-determined level set by the power management and charge controller, the power from the power supply jack will start charging the FC battery again, and the FC battery will cease charging the internal battery of the mobile electronic device. The process of alternatively charging from the power supply jack and from the FC battery will continue until the internal battery of the mobile electronic device and the FC battery are fully charged. When the power supply jack is removed, the internal battery of the mobile electronic device will start to take power from the FC battery.

### BRIEF DESCRIPTION OF THE DRAWINGS

The system and method of the present invention is further described with reference to the accompanying drawings in which:

FIG. 1 is a top plan view of the rapid charging mobile electronic device battery case of the present invention.

FIG. 2 is a front plan view of the rapid charging mobile electronic device battery case of the present invention, assembled together with a mobile electronic device.

FIG. 3 is a bottom plan view of the rapid charging mobile electronic device battery case of the present invention.

FIG. 4 is a left side plan view of the rapid charging mobile electronic device battery case of the present invention.

FIG. 5 is a side plan view of a power supply power jack that feeds into the top of the rapid charging mobile electronic device battery case of the present invention.

FIG. 6 is a right side plan view of the rapid charging mobile electronic device battery case of the present invention.

FIG. 7 is a back plan view of the rapid charging mobile electronic device battery case of the present invention.

FIG. 8 is a right side plan view of the rapid charging mobile electronic device battery case of the present invention, showing the end piece that is removed in order to remove the mobile electronic device from the rapid charging mobile electronic device battery case.

FIG. 9 is a top plan view of the rapid charging mobile electronic device battery case of the present invention.

FIG. 10 is a front plan view of the rapid charging mobile electronic device battery case of the present invention.

FIG. 11 is a front perspective view of the rapid charging mobile electronic device battery case of the present invention.

FIG. 12 is a left side plan view of the rapid charging mobile electronic device battery case of the present invention.

FIG. 13 is a right side plan view of the rapid charging mobile electronic device battery case of the present invention.

FIG. 14 is a back plan view of the rapid charging mobile electronic device battery case of the present invention.

FIG. 15 is a back perspective view of the rapid charging mobile electronic device battery case of the present invention.

FIG. 16 is an exploded perspective view of the rapid charging mobile electronic device battery case of the present invention.

FIG. 17 depicts the circuit flow between the components of the rapid charging mobile electronic device battery case of the present invention.

FIG. 18 depicts the circuit flow in a first embodiment of the charging circuit of the rapid charging mobile electronic device battery case of the present invention.

FIG. 19 depicts the circuit flow in a second embodiment of the charging circuit of the rapid charging mobile electronic device battery case of the present invention.

FIG. 20 depicts the circuit flow in a third embodiment of the charging circuit of the rapid charging mobile electronic device battery case of the present invention.

FIG. 21 depicts the circuit flow in a fourth embodiment of the charging circuit of the rapid charging mobile electronic device battery case of the present invention.

FIG. 22 depicts the circuit flow in a fifth embodiment of the charging circuit of the rapid charging mobile electronic device battery case of the present invention.

FIG. 23 depicts the circuit flow in a sixth embodiment of the charging circuit of the rapid charging mobile electronic device battery case of the present invention.

FIG. 24 depicts the circuit flow in a seventh embodiment of the charging circuit of the rapid charging mobile electronic device battery case of the present invention.

### DETAILED DESCRIPTION OF THE ILLUSTRATED EMBODIMENTS

An illustrated embodiment, shown in FIGS. 1-8, of the rapid charging mobile electronic device battery case 10 of the present invention comprises a charging circuit 12, a fast charging (FC) battery 14, a battery enclosure 16, and a power supply jack input 18. The charging circuit 12 controls the power coming from the power supply jack input 18 to the FC battery 14 and to the internal battery of the mobile electronic device 20 and from the FC battery 14 to the internal battery of the mobile electronic device 20. The FC battery 14 includes any battery or other energy storage unit that charges from zero to full charge in less than fifteen minutes and has a capacity greater than 1200 mAh. The battery enclosure 16 houses the charging circuit 12 and the FC battery 14. The power supply jack input 18 is adapted to be connected to any AC to DC or DC to DC power source that is able to provide between 30 and 100 watts of power. The mobile electronic device 20 includes any mobile electronic device that uses an advanced operating system such as iOS from Apple or Android from Google.

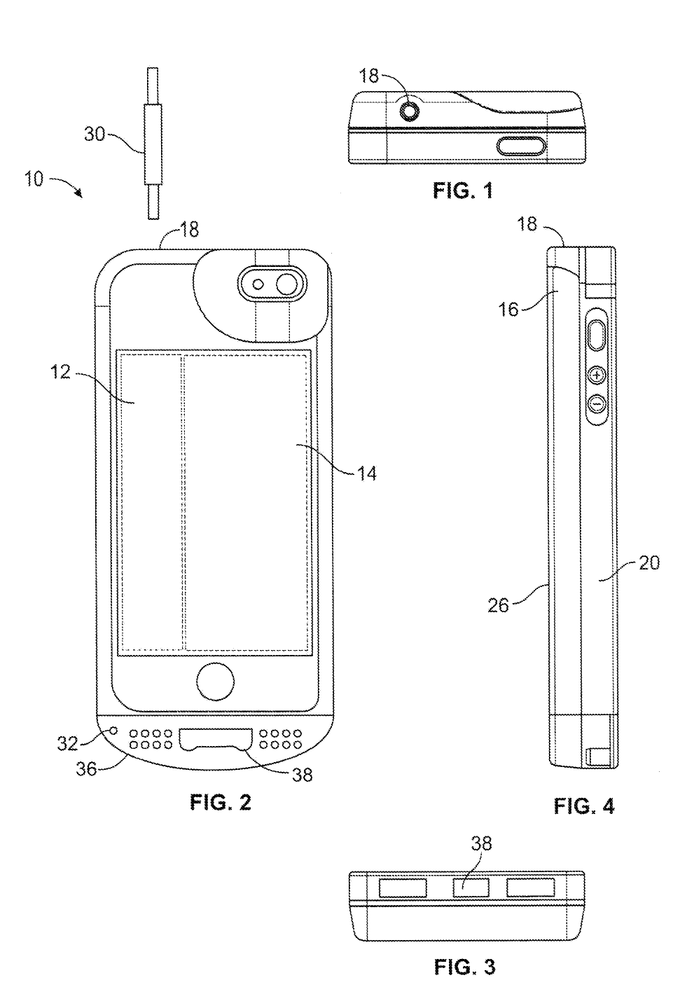

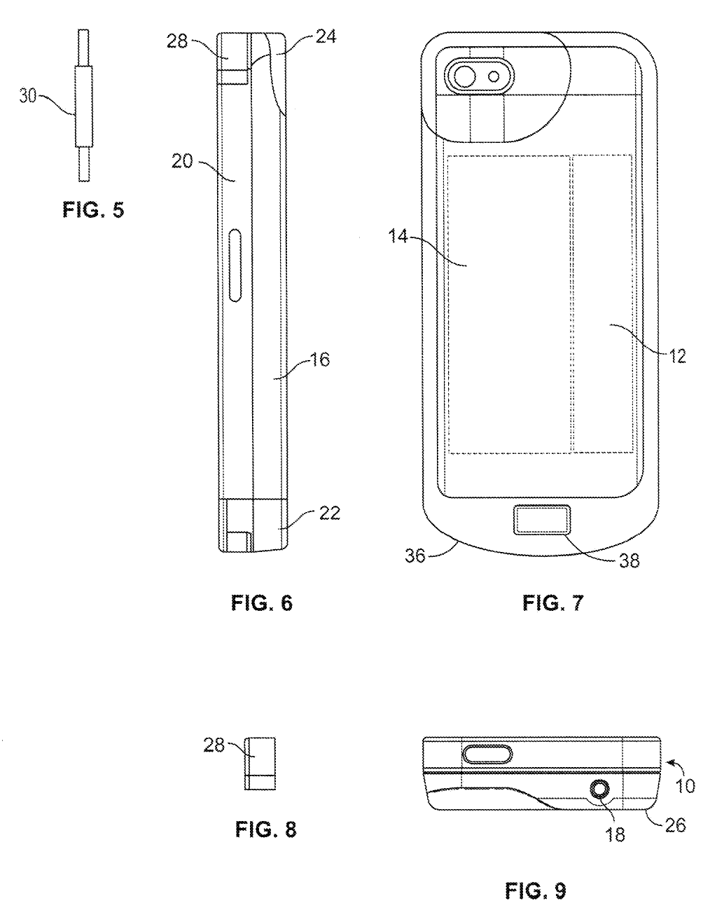

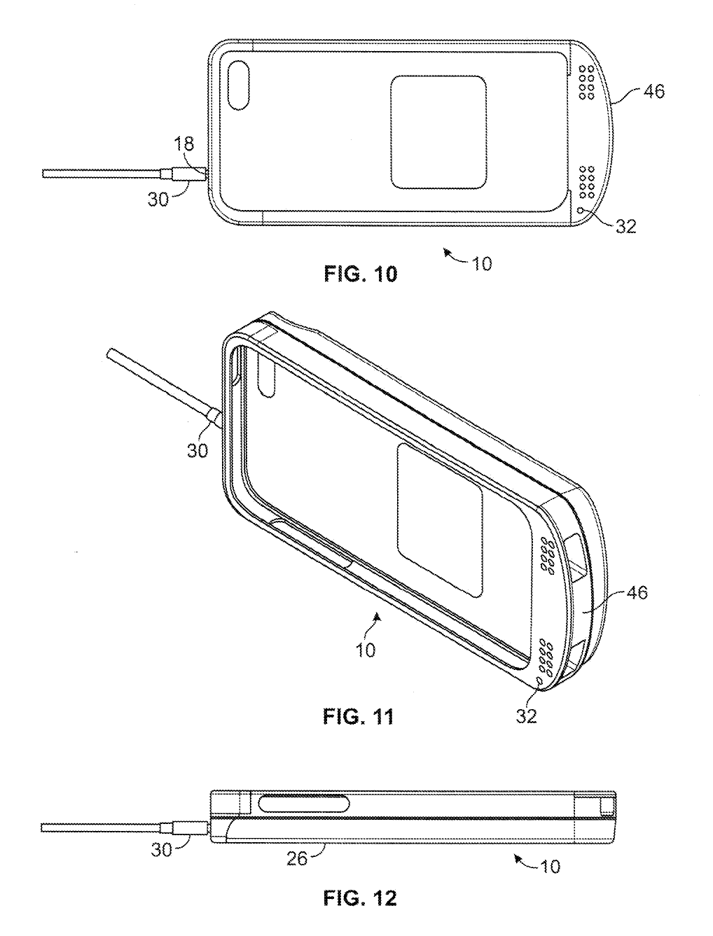

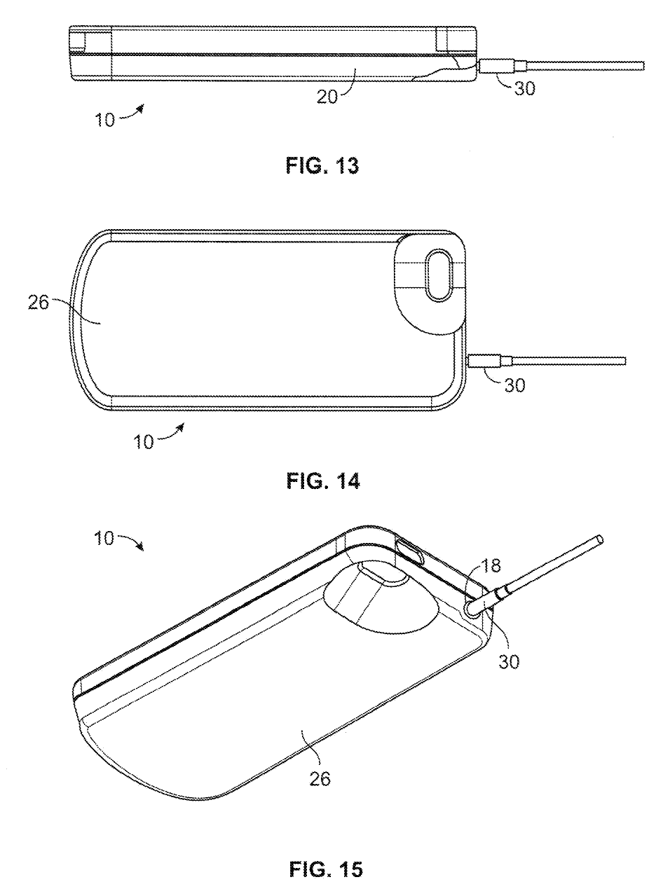

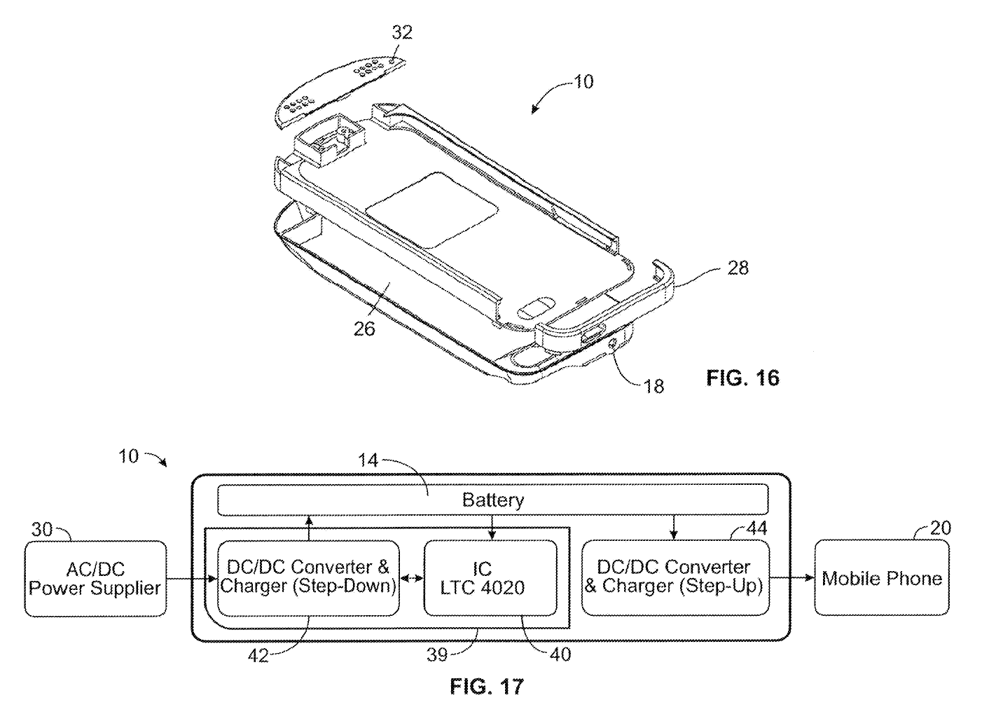

Referring to FIG. 6, the battery enclosure 16 comprises a base portion 22 and a detachable top portion 24. The battery enclosure 16 fits snugly around the mobile electronic device 20, which is designed to contain and protect the mobile electronic device 20. The user has access to the buttons and touch screen of the mobile electronic device 20 either directly through apertures in the battery enclosure 16 or indirectly through button features included on the sides of the base portion 22. The battery enclosure 16 also includes speaker apertures that allow the mobile electronic device 20 speakers to be fully exposed. The mobile electronic device 20 is inserted into the battery case 10 by sliding the mobile electronic device 20 into the top portion 24 and then attaching the top end piece 28 (FIG. 6, 8) to the top portion 24 of the battery enclosure 16. The power supply jack 30 (FIG. 5) connects to the power supply jack input 18 located at the top of the battery enclosure 16, shown in FIGS. 2 and 5. The battery enclosure 16 includes an LED indicator 32 (FIG. 10) that indicates when the FC battery 14 is charged while the power supply jack 30 is connected to the power supply jack input 18. The LED indicator 32 will stay lit until the power supply jack 30 is disconnected from the power supply jack input 18. The battery case 10 uses an internal algorithm to control when the battery case 10 is on, off, charging, and discharging.

In an alternate embodiment, the battery enclosure 16 includes controls that allow a user to turn the battery case 10 on and off and check the charge level of the FC battery 14. The charge level may be indicated by LED lights located on the front surface of the battery enclosure 16. The controls may also include at least one light that is illuminated when the battery case 10 is on and is providing energy to the mobile electronic device 20 or if the charge level is being tested. The light corresponding to the controls may turn off when the battery case 10 is not being used to provide energy to the mobile electronic device 20, such as when the user presses the control to turn the power off or when the FC battery 14 runs out of energy. Alternatively, the battery case 10 can be controlled via a mobile application or software program in the mobile electronic device 20, eliminating the need for controls and lights in the battery enclosure 16.

In some embodiments, the back panel 26 (FIG. 4) of the battery enclosure 16 is made of a lighter plastic or polymeric material than the inside panel in order to reduce the total weight of the battery case 10. Additionally, the material may be impact resistant enough to resist fracture when the battery case 10 containing a mobile electronic device 20 is dropped from a user's hand, table, desk, or a similar height onto a variety of surfaces including concrete, asphalt, carpet, and the like at a variety of heights. The material may also exhibit beneficial properties such as scratch resistance, fire resistance, elastic modulus, and the like. In one embodiment, the battery case 10 has an elliptical bottom 36 (FIGS. 2, 7), thereby protecting the mobile electronic device 10 from damage due to a fall by distributing the force of the impact.

FIG. 2 illustrates a schematic front plan view of the battery case 10 showing the electrical components of the charging circuit 12. The battery enclosure 16 includes the charging circuit 12 and the FC battery 14. The charging circuit 12 includes one printed circuit board (PCB), which along with FC battery 14 is housed within the battery enclosure 16. The PCB may include firmware, a controller, an authentication chip, a power management and charge controller, light emitting diodes (LEDs), and a case connector such as a 30-pin connector, a micro USB connector, or lightning connector. The charging circuit 12 includes at least one or multiple battery management integrated circuits (IC) and a method of converting the fluctuating FC battery 14 voltage or the power supply voltage to a constant voltage useable by the mobile electronic device 20, such as a switching regulator or a buck/boost converter. Once the voltage is converted, the power is then transferred to the mobile electronic device 20. When the FC battery 14 reaches a certain voltage, typically 3.0 V, the FC battery 14 stops discharging in order to prevent damage to the FC battery 14.

The main purpose of the charging circuit 12 is to rapidly recharge the FC battery 14 inside of the battery enclosure 16 when the power supply jack 30 is electrically connected to an external power supply, such as a 120 volt wall socket. The circuit is designed to take in 35 watts regardless of what type of external power supply is electrically connected to the battery case 10. The battery enclosure 16 includes the charging circuit 12 that hosts the circuitry necessary to quickly recharge the FC battery 14. The charging circuit 12 may include an authentication chip to prevent inadvertently charging an incompatible mobile electronic device or other device, and a control chip used to initiate charging, identification, etc. The charging circuit 12 also has an input for power from a power supply. The charging circuit 12 may also incorporate a cooling system such as a heat sink, a fan, and the like.

In this embodiment, the FC battery 14 is located on the right side of the battery enclosure 16, shown in FIGS. 2 and 7. In alternate embodiments, the FC battery 14 may be located in any portion of the battery enclosure 16. The FC battery 14 may be able to hold 3.7V at 2500 mAh capacity, at 1700 mAh capacity, at 1600 mAh capacity, at 1200 mAh capacity, and the like. The FC battery 14 can be a lithium ion battery, a nickel cadmium battery, a nickel metal hydride battery, a lithium-ion polymer battery, a lithium polymer battery, a lithium-air battery, a fuel cell battery, a lead acid battery, a super-capacitor battery, or any other type of rechargeable battery or means of energy storage. In one embodiment, the FC battery 14 is a Thunderpower G8 battery.

The external power supply to which power supply jack 30 is electrically connected, as is known in the art, is packaged with, or sold separately from, the rapid charging mobile electronic device battery case 10 of the present invention. The power supply is one of an automobile 12V DC cigarette lighter power supply, a portable power supply that is similar in size to a typical mobile electronic device power supply that meets the power requirements of the power supply, and a laptop power supply that meets the power requirements of the power supply. All power supplies include the proper power supply jack 30 to plug into the battery case 10 power supply jack input 18, shown in FIG. 1, at the top of the battery enclosure 16. The power from the power supply jack 30 is fed into the charging circuit 12 via the power supply jack input 18 in the battery enclosure 16. The battery enclosure 16 includes a mobile electronic device 20 and an electrical connector 38, shown in FIGS. 2, 3, and 7, that feeds power from the FC battery 14 and the power supply jack input 18 via the charging circuit 12 into the internal battery of the mobile electronic device 20 for charging the mobile electronic device 20.

The “C” rating is the rate of charge relative to capacity. A 1 C rate of charge in an 1800 mAh cell would mean a continuous charge current of 1.8 amps, while a 10 C rate of charge would be 18 amps. The most common charging methodology for lithium battery cells is the constant current/constant voltage (CC/CV) method. In the embodiment shown in FIG. 2, power is transferred from the power supply jack input 18 to the charging circuit 12 in the battery enclosure 16. The charging circuit 12 includes a battery charging integrated circuit (IC) 40 (FIG. 17) that is configured to recharge the FC battery 14 inside of the battery enclosure 16 at a rate several times higher than 1 C, such as 5 C, 8 C, 10 C, 12 C, and up. The battery case 10 and power supply combination has the necessary circuitry to charge the FC battery 14 at a rate of typically 5-12 C and up, and is adequately thin to allow easy portability.

The charging circuit 12 begins operating when the power supply jack 30 is connected to the power supply jack input 18 providing DC current from an AC or DC power source, charging the FC battery 14 to a full charge and simultaneously charging the internal battery of the mobile electronic device 20 using the current from the power supply jack 30. When the FC battery 14 is fully charged, the LED indicator 32 (FIGS. 2, 10) lights up to indicate that the FC battery is fully charged and power from the battery IC 40 is shut off to both the FC battery 14 and the internal battery of the mobile electronic device 20, preventing both from drawing power from the power supply. When the power supply jack 30 is connected to the battery case 10, the LED indicator 32 will blink at a speed that is proportional to the rate of charge of the fast charging battery 14. The blinking will initially be fast, about three times per second, and then will continuously slow down until it reaches a constant fully lit state indicating that the fast charging battery 14 is fully charged. The blink rate should never be slower than one blink every two seconds. The LED indicator 32 will stay lit as long as the power supply jack 30 is connected to the battery case 10. When the power supply jack 30 is removed, the LED indicator 32 will turn off.

The step-up DC/DC converter 44 continues to put out 5V for the attached mobile electronic device to use, when the FC battery 14 is charging. When the power supply jack 30 is disconnected from the battery enclosure 16 or when the charge of the FC battery 14 is above a predetermined safe level, the FC battery 14 releases charge to the step-up DC/DC converter 44 which increases the voltage of the power and powers the connected mobile electronic device 20. The mobile electronic device charging indicator is lit as long as there is power in the FC battery 14 or the battery case 10 is plugged into the external power supply. When the battery case 10 is no longer charging the internal battery of the mobile electronic device 20, the charging indicator on the mobile electronic device 20 turns off, indicating that the FC battery 14 in battery case 10 no longer has any power and needs to be recharged. In one embodiment, the mobile electronic device charging indicator is the battery icon in the upper right corner of an Apple iPhone, for example, indicating charge status and percent charged.

FIG. 17 shows the power flow and information flow from the external power supply to the FC battery 14 and the mobile electronic device 20. The power supply first flows through power supply jack 30 into a step-down DC/DC converter and charger 42 of a battery charger 39 within the battery enclosure 16. The current is then sent from the step-down DC/DC converter 42 to the battery IC 40, which is power management and charge controller, of the battery charger 39 and the FC battery 14. The battery IC 40 sends current back to the step-down DC/DC converter 42. The FC battery 14 sends current to the battery IC 40 and to a step-up DC/DC converter and charger 44. The step-up DC/DC converter 44 then sends the current to the mobile electronic device 20. The battery IC 40 includes built-in functionality that provides 5 W of power to the internal battery of the mobile electronic device 20 simultaneously while the FC battery 14 is charging. When the FC battery 14 is not charging and the charge of the FC battery 14 is above a predetermined safe level, the internal battery of the mobile electronic device 20 will draw power from the FC battery 14 instead of the battery IC 40.

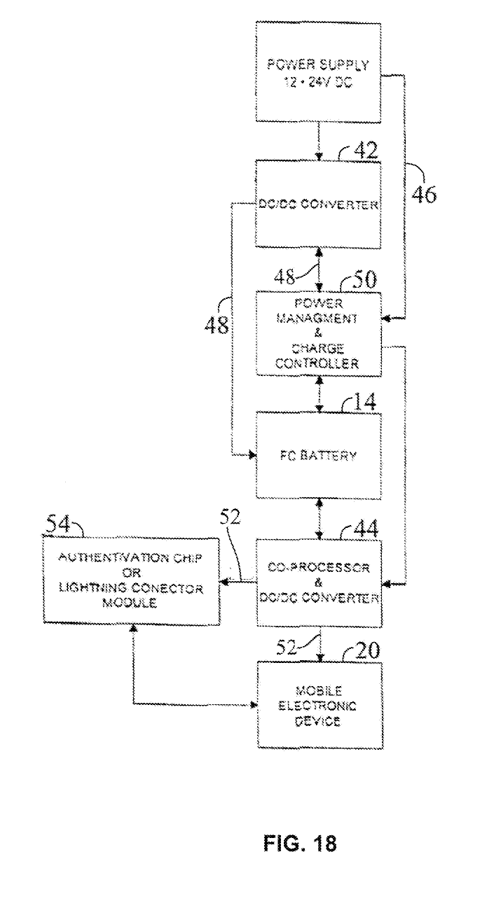

The battery case 10 of the present invention uses an internal algorithm to perform the charging process, a first embodiment shown in FIG. 18 which depicts the power flow and information flow between components. Arrows in FIG. 18 show power flow and information flow about voltage and current. The power management and charge controller 50, such as the LTC4020, requires information about the voltage value of the FC battery 14 and the charging current in order to charge the battery correctly and safely. The entire charging process is controlled by a buck boost battery charger 39 (FIG. 17), such as an LTC4020 buck-boost multi-chemistry battery charger, which includes a step-down DC/DC converter and charger 42. The step-down DC/DC converter and charger 42 lowers the voltage from the input voltage of the external power supply to match the FC battery 14 voltage. The step-up DC/DC converter and charger 44 is an independent processor that increases the battery voltage to 5.0V as required by the mobile electronic device 20. The power supply 41 provides 12-24V DC current that passes through the step-down DC/DC converter 42 to lower the voltage of the current. The original current 46 from the power supply and the lowered voltage current 48 flow to the power management and charge controller 50. The power management and charge controller 50 flows back into the step-down DC/DC converter 42 and into the FC battery 14. The FC battery 14 and the power management and charge controller 50 both provide current and information to the co-processor and step-up DC/DC converter 44. The co-processor and step-up DC/DC converter 44 also provides 5 W of power to the internal battery of the mobile electronic device 20, simultaneously, while the FC battery 14 is charging or when the charge of the FC battery 14 is below a predetermined safe level. The step-up converter increases the voltage of the current to a level that can charge the internal battery of the mobile electronic device 20. The increased voltage current 52 then flows into the authentication chip or lightning connector module 54 and into the mobile electronic device 20. The FC battery 14 provides power to the internal battery of the mobile electronic device 20 when the power supply jack 30 is disconnected from the battery case 10 and when the charge of the FC battery is at or above a predetermined safe level, the safe level set internally by the power management and charge controller 50.

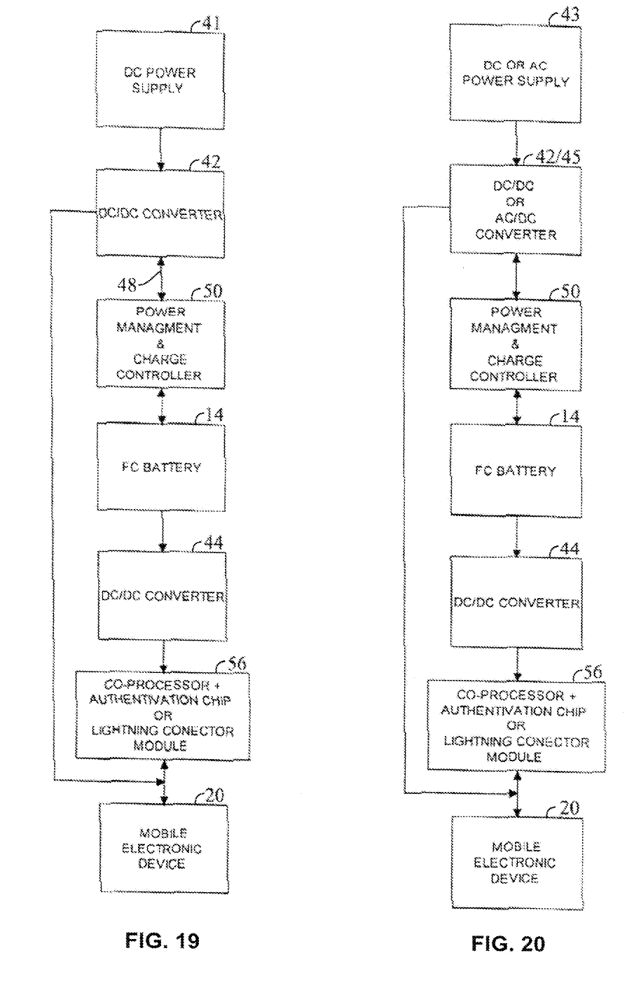

A second embodiment of the charging process is shown in FIG. 19, which depicts the power flow and information flow between components. Arrows in FIG. 19 show power flow and information flow about voltage and current. The power management and charge controller 50, such as the LTC4020, requires information about the voltage value of the FC battery 14 and the charging current in order to charge the battery correctly and safely. Power is provided by the DC power supply 41 and flows into the step-down DC/DC converter 42. The step-down DC/DC converter 42 lowers the voltage from the input voltage of the power supply 41 to match the FC battery 14 voltage. The step-down DC/DC converter 42 sends information and the reduced voltage power to the power management and charge controller 50 and sends only the reduced voltage power to the co-processor and authentication chip/lightning connector module 56 and to the mobile electronic device 20. The power management and charge controller 50 sends information and power to the step-down DC/DC converter 42 and to the FC battery 14. The FC battery 14 sends power and voltage and current information to the power management and charge controller 50 and sends only power to the step-up DC/DC converter 44. The step-up DC/DC converter 44 increases the voltage of the current to a level that can charge the internal battery of the mobile electronic device 20. The step-up DC/DC converter 44 then sends the increased voltage power to the co-processor and authentication chip/lightning connector module 56. The co-processor and authentication chip/lightning connector module 56 sends information and the increased voltage power to the mobile electronic device 20 and the mobile electronic device 20 sends voltage and current information and power to the co-processor and the lightning connector module 56 to get information and the authentication number from the mobile electronic device 20. After the lightning connector module receives power from the mobile electronic device 20, the lightning connector module sends an authentication number to the mobile electronic device 20.

A third embodiment of the charging process is shown in FIG. 20, which depicts the power flow and information flow between components. Arrows in FIG. 20 show power flow and information flow about voltage and current. The power management and charge controller 50, such as the LTC4020, requires information about the voltage value of the FC battery 14 and the charging current in order to charge the battery correctly and safely. Power is provided by the DC or AC power supply 43 and flows into the step-down DC/DC converter 42 or AC/DC converter 45. The step-down DC/DC converter 42 or AC/DC converter 45 lowers the voltage from the input voltage of the power supply 43 to match the FC battery 14 voltage. The step-down DC/DC converter 42 or AC/DC converter 45 sends the reduced voltage power and the voltage and current information to the power management and charge controller 50 and sends the reduced power voltage to the co-processor and authentication chip/lightning connector module 56 and to the mobile electronic device 20. The power management and charge controller 50 sends power and the voltage and current information to the step-down DC/DC converter 42 or AC/DC converter 45 and to the FC battery 14. The FC battery 14 sends voltage and current information and power to the power management and charge controller 50 and sends power to the step-up DC/DC converter 44. The step-up DC/DC converter 44 increases the voltage of the current to a level that can charge the internal battery of the mobile electronic device 20. The step-up DC/DC converter 44 then sends the increased voltage power to the co-processor and authentication chip/lightning connector module 56. The co-processor and authentication chip/lightning connector module 56 sends the power and the voltage and current information to the mobile electronic device 20 and the mobile electronic device 20 sends the power and voltage and current information to the co-processor and the lightning connector module 56 to get information and the authentication number from the mobile electronic device 20. After the lightning connector module receives power from the mobile electronic device 20, the lightning connector module sends an authentication number to the mobile electronic device 20.

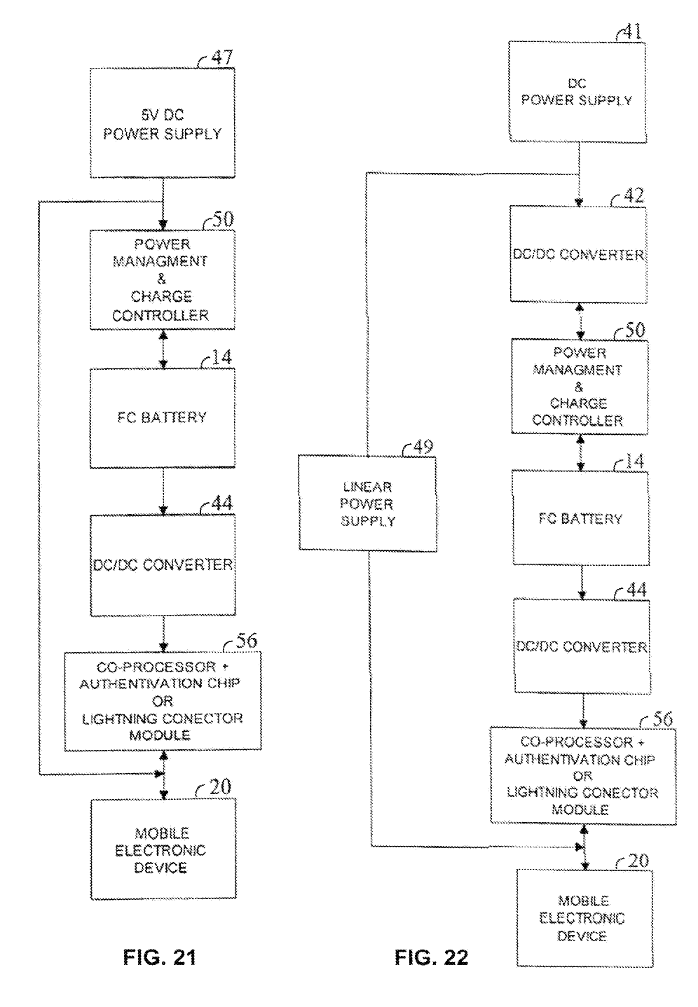

A fourth embodiment of the charging process is shown in FIG. 21 which depicts the power flow and information flow between components. Arrows in FIG. 18 show power flow and information flow about voltage and current. The power management and charge controller 50, such as the LTC4020, requires information about the voltage value of the FC battery 14 and the charging current in order to charge the battery correctly and safely. Power is provided by a 5V DC power supply 47 and flows into the power management and charge controller 50, to the co-processor and authentication chip/lightning connector module 56, and to the mobile electronic device 20. The power management and charge controller 50 sends the power and voltage and current information to the FC battery 14. The FC battery 14 sends power and voltage and current information to the power management and charge controller 50 and sends power to the step-up DC/DC converter 44. The step-up DC/DC converter 44 increases the voltage of the current to a level that can charge the internal battery of the mobile electronic device 20. The step-up DC/DC converter 44 then sends the increased voltage power to the co-processor and authentication chip/lightning connector module 56. The co-processor and authentication chip/lightning connector module 56 sends the power and the voltage and current information to the mobile electronic device 20 and the mobile electronic device 20 sends power and the voltage and current information to the co-processor and the lightning connector module 56 to get information and the authentication number from the mobile electronic device 20. After the lightning connector module receives power from the mobile electronic device 20, the lightning connector module sends an authentication number to the mobile electronic device 20.

A fifth embodiment of the charging process is shown in FIG. 22 which depicts the power flow and information flow between components. Arrows in FIG. 22 show power flow and information flow about voltage and current. The power management and charge controller 50, such as the LTC4020, requires information about the voltage value of the FC battery 14 and the charging current in order to charge the battery correctly and safely. Power is provided by the DC power supply 41 and flows into the step-down DC/DC converter 42 and to the linear power supply 49. The linear power supply 49 sends power to the co-processor and authentication chip/lightning connector module 56 and to the mobile electronic device 20. The step-down DC/DC converter 42 lowers the voltage from the input voltage of the power supply 41 to match the FC battery 14 voltage. The step-down DC/DC converter 42 sends the reduced voltage power and voltage and current information to the power management and charge controller 50. The power management and charge controller 50 sends the power and voltage and current information back to the step-down DC/DC converter 42 and to the FC battery 14. The FC battery 14 sends power and voltage and current information to the power management and charge controller 50 and sends power to the step-up DC/DC converter 44. The step-up DC/DC converter 44 increases the voltage of the current to a level that can charge the internal battery of the mobile electronic device 20. The step-up DC/DC converter 44 then sends the increased voltage power to the co-processor and authentication chip/lightning connector module 56. The co-processor and authentication chip/lightning connector module 56 sends the power and voltage and current information to the mobile electronic device 20 and the mobile electronic device 20 sends power and voltage and current information to the co-processor and the lightning connector module 56 to get information and the authentication number from the mobile electronic device 20. After the lightning connector module receives power from the mobile electronic device 20, the lightning connector module sends an authentication number to the mobile electronic device 20.

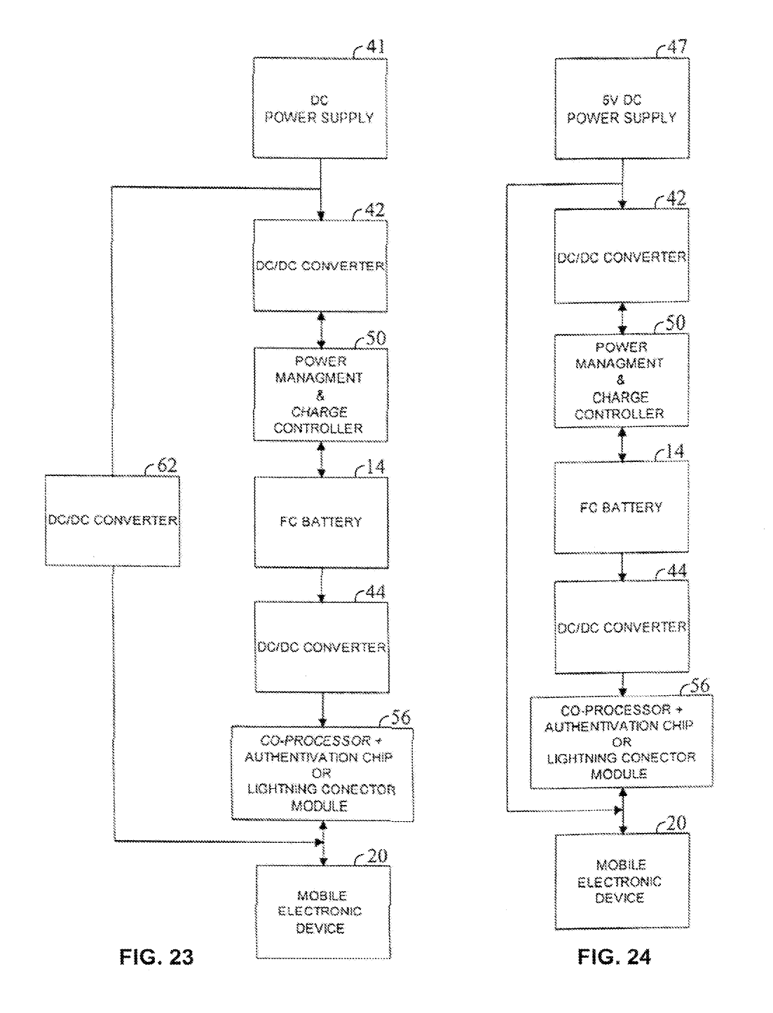

A sixth embodiment of the charging process is shown in FIG. 23 which depicts the power flow and information flow between components. Arrows in FIG. 23 show power flow and information flow about voltage and current. The power management and charge controller 50, such as the LTC4020, requires information about the voltage value of the FC battery 14 and the charging current in order to charge the battery correctly and safely. Power is provided by the DC power supply 41 and flows into two step-down DC/DC converters 42, 62. The first step-down DC/DC converter 42 lowers the voltage from the input voltage of the power supply 41 to match the FC battery 14 voltage and the second step-down DC/DC converter 62 lowers the voltage from the input voltage of the power supply 41 to match the voltage of the mobile electronic device 20. The first step-down DC/DC converter 42 sends the reduced voltage power and voltage and current information to the power management and charge controller 50 and the second step-down DC/DC converter 62 sends the reduced voltage power to the co-processor and authentication chip/lightning connector module 56 and to the mobile electronic device 20. The power management and charge controller 50 sends the power and voltage and current information back to the step-down DC/DC converter 42 and to the FC battery 14. The FC battery 14 sends power and voltage and current information to the power management and charge controller 50 and sends power to the step-up DC/DC converter 44. The step-up DC/DC converter 44 increases the voltage of the current to a level that can charge the internal battery of the mobile electronic device 20. The step-up DC/DC converter 44 then sends the increased voltage power to the co-processor and authentication chip/lightning connector module 56. The co-processor and authentication chip/lightning connector module 56 sends the power and voltage and current information to the mobile electronic device 20 and the mobile electronic device 20 sends power and voltage and current information to the co-processor and the lightning connector module 56 to get information and the authentication number from the mobile electronic device 20. After the lightning connector module receives power from the mobile electronic device 20, the lightning connector module sends an authentication number to the mobile electronic device 20.

A seventh embodiment of the charging process is shown in FIG. 24 which depicts the power flow and information flow between components. Arrows in FIG. 24 show power flow and information flow about voltage and current. The power management and charge controller 50, such as the LTC4020, requires information about the voltage value of the FC battery 14 and the charging current in order to charge the battery correctly and safely. Power is provided by a 5V DC power supply 47 and flows into the step-down DC/DC converter 42, to the co-processor and authentication chip/lightning connector module 56, and to the mobile electronic device 20. The step-down DC/DC converter 42 lowers the voltage from the input voltage of the power supply 47 to match the FC battery 14 voltage. The step-down DC/DC converter 42 sends the reduced voltage power and voltage and current information to the power management and charge controller 50. The power management and charge controller 50 sends the power and voltage and current information back to the step-down DC/DC converter 42 and to the FC battery 14. The FC battery 14 sends power and voltage and current information to the power management and charge controller 50 and sends power to the step-up DC/DC converter 44. The step-up DC/DC converter 44 increases the voltage of the current to a level that can charge the internal battery of the mobile electronic device 20. The step-up DC/DC converter 44 then sends the increased voltage power to the co-processor and authentication chip/lightning connector module 56. The co-processor and authentication chip/lightning connector module 56 sends the power and voltage and current information to the mobile electronic device 20 and the mobile electronic device 20 sends power and voltage and current information to the co-processor and the lightning connector module 56 to get information and the authentication number from the mobile electronic device 20. After the lightning connector module receives power from the mobile electronic device 20, the lightning connector module sends an authentication number to the mobile electronic device 20.

There are three phases in the charging process. In the first phase when the FC battery 14 was discharged below a safe level, the FC battery 14 is charged with a current rate of 0.1 C until the FC battery 14 reaches a voltage of 3.0V in order to prevent any permanent damage to the battery. A current rate higher than 0.1 C, when the FC battery 14 voltage is between 2.7V and 3.0V, will permanently damage the battery. Once the voltage reaches 3.0V, the charging process switches to a constant current. In the second phase, the FC battery 14 is charged with the current of constant value at the charge rate of 5.5 C-12 C, quickly increasing the voltage of the FC battery 14. When the FC battery 14 reaches a voltage of 4.2V, the circuit enters constant voltage mode (CV). In this second phase, the CV phase, the charging current rate slowly decreases in order to maintain 4.2V of charge. Once the rate falls to Cₘₐₓ/10, the FC battery 14 is about 90% charged. At this point, the charge may be terminated or switched to a third phase. The third phase is a trickle charge where the FC battery 14 is slowly charged at 0.1 C. In the present invention, the FC battery 14 is charged from empty to 90% in about 8-10 minutes. In some embodiments, the second or third phase is limited by a timer to avoid overcharging the FC battery 14.

The battery IC 40, which is a power management and charge controller, provides 5 W of power to the internal battery of the mobile electronic device 20 when the battery case 10 is electrically connected to the power supply jack 30 and either the FC battery 14 is charging or the charge of the FC battery 14 is below a predetermined safe level. When the FC battery 14 is not charging and the charge of the FC battery 14 is above a predetermined safe level, the internal battery of the mobile electronic device 20 will draw power from the FC battery 14 instead of the battery IC 40 even though the battery case 10 is electrically connected to the power supply jack 30. Once the power supply jack 30 is disconnected from the battery case 10, the FC battery 14 continues to provide power to the internal battery of the mobile electronic device 20.

The foregoing description of an illustrated embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A rapid charging battery case for a mobile electronic device having an electronic screen display, comprising:
a. a protective casing having an aperture adapted to surround and provide visual access to the electronic screen display, the casing having internal dimensions substantially the same as the external dimensions of the mobile electronic device, said casing adapted to fit snugly around the mobile electronic device;
b. a fast charging battery within the protective casing;
c. a charging circuit adapted to provide current to the fast charging battery; and
d. the charging circuit adapted to be electrically connected to an electrical power supply.

2. The rapid charging battery case of claim 1, wherein the protective casing includes a detachable top portion and a base portion.

3. The rapid charging battery case of claim 2, wherein the protective casing includes an LED indicator on one of the top portion and base portion, the LED indicator adapted to indicate when the fast charging battery is charging.

4. The rapid charging battery case of claim 1, wherein the protective casing includes an input for a 3.5 mm diameter power jack.

5. The rapid charging battery case of claim 1, wherein the protective casing includes a back panel and an inside panel.

6. The rapid charging battery case of claim 5, wherein the back panel is made of a lighter material than the inside panel.

7. The rapid charging battery case of claim 1, wherein the protective casing is made of one of a plastic material and a polymeric material.

8. The rapid charging battery case of claim 1, wherein the protective casing is at least one of impact resistant, fire resistant, and scratch resistant.

9. The rapid charging battery case of claim 2, wherein the bottom portion includes an elliptical bottom adapted to distribute impact forces and protect the mobile electronic device.

10. The rapid charging battery case of claim 1, wherein the charging circuit includes a printed circuit board and at least one battery management integrated circuit.

11. The rapid charging battery case of claim 10, wherein the printed circuit board includes at least one of firmware, a controller, an authentication chip, an integrated circuit, a light emitting diode, and a case connector.

12. The rapid charging battery case of claim 1, wherein the fast charging battery is one of a lithium ion battery, a nickel cadmium battery, a nickel metal hydride battery, a lithium-ion polymer battery, a lithium polymer battery, a lithium-air battery, a fuel cell battery, a lead acid battery, a super-capacitor battery, and a rechargeable battery.

13. The rapid charging battery case of claim 1, wherein the charging circuit includes at least one of a battery charger and a step-up DC/DC converter.

14. The rapid charging battery case of claim 13, wherein the battery charger includes an LTC4020.

15. The rapid charging battery case of claim 13, wherein the battery charger includes a step-down DC/DC converter.

16. The rapid charging battery case of claim 1, wherein the fast charging battery is a Thunderpower G8 battery.

17. The rapid charging battery case of claim 1, wherein the protective casing includes apertures adapted to allow access to at least one speaker of the mobile electronic device.

18. The rapid charging battery case of claim 1, wherein the protective casing includes at least one beveled side, the casing adapted to stand firmly on the beveled side to enable hands-free viewing of the electronic screen display.

19. A method for charging a fast charging battery in a battery case and an internal battery of mobile electronic device, the method comprising the steps of:
a. receiving a first power from an external power supply through a power jack and sending the first power to a step-down DC/DC converter;
b. converting the first power to a second power with a lower voltage at a first charge rate via the step-down DC/DC converter when the fast charging battery has less than a first predetermined voltage;
c. sending at least one of the second power, voltage information, and current information to the fast charging battery and charging the fast charging battery until the fast charging battery has at least the first predetermined voltage;
d. converting the first power to 5 W of power and sending 5 W of power to the internal battery of the mobile electronic device via an electrical connector that electrically connects the battery case to the mobile electronic device when one of the fast charging battery is charging and the charge of the fast charging battery is below a predetermined safe level;
e. converting the first power to a third power with a constant current at a second charge rate when the fast charging battery has less than a second predetermined voltage;
f. sending the third power to the fast charging battery and charging the fast charging battery until the fast charging battery has at least the second predetermined voltage;
g. gradually lowering the third power in order to maintain the fast charging battery at at least the second predetermined voltage;
h. converting the first power to the second power with a lower voltage at the first charge rate via the step-down DC/DC converter when the fast charging battery has at least the second predetermined voltage; and
i. sending the second power to the fast charging battery and charging the fast charging battery until the fast charging battery has a full charge.

20. The method of claim 19, further comprising the steps of:
a. receiving a fourth power from the fast charging battery;
b. converting the fourth power to a fifth power having a voltage of 5.0V via a step-up DC/DC converter; and
c. sending the fifth power to the mobile electronic device via the electrical connector and charging the internal battery.

21. The method of claim 19, wherein the first power is received from the external power supply through a 3.5 mm diameter power jack.

22. The method of claim 19, wherein the first charge rate is 0.1 C.

23. The method of claim 19, wherein the first predetermined voltage is 3.0V.

24. The method of claim 19, wherein the second charge rate is at least 8 C.

25. The method of claim 19, wherein the second predetermined voltage is 4.2V.

26. A method for charging a fast charging battery in a battery case and an internal battery of a mobile electronic device, the method comprising the steps of:
a. receiving a first power from an external power supply through a power jack and sending the first power to a step-down DC/DC converter;
b. converting the first power to a second power with a lower voltage via the step-down DC/DC converter;
c. sending at least one of the second power, voltage information, and current information to the power management and charge controller and sending the second power to a co-processor, one of an authentication chip and a lightning connector module, and the mobile electronic device;
d. the power management and charge controller sending at least one of the second power, voltage information, and current information to the step-down DC/DC converter and to the fast charging battery until the fast charging battery has at least a first predetermined voltage;
e. the fast charging battery sending at least one of a third power, voltage information, and current information to the power management and charge controller and sending a third power to a step-up DC/DC converter;
f. converting the third power to a fourth power having a voltage of 5.0V via a step-up DC/DC converter;
g. sending the fourth power to the co-processor and one of the authentication chip and lightning connector module;
h. the co-processor and one of the authentication chip and lightning connector module sending at least one of the fourth power, voltage information, and current information to the mobile electronic device; and
i. the mobile electronic device sending at least one of the fourth power, voltage information, and current information to the co-processor and one of the authentication chip and lightning connector module.

27. The method of claim 26, wherein the first power is received from the external power supply through a 3.5 mm diameter power jack.

28. The method of claim 26, wherein the power supply is one of a 12-24V DC power supply, an AC power supply, and a 5V DC power supply.

29. The method of claim 26, wherein the first predetermined voltage is 3.0V.

30. The method of claim 26, further comprising the steps of:
a. sending the first power to a linear power supply; and
b. the linear power supply sending a fifth power to a co-processor and one of an authentication chip and a lightning connector module and to the mobile electronic device.

31. A method for charging a fast charging battery in a battery case and an internal battery of a mobile electronic device, the method comprising the steps of:
a. receiving a first power from an external power supply through a power jack and sending the first power to at least one of a power management and charge controller, to a co-processor and one of an authentication chip and a lightning connector module, and to the mobile electronic device;
b. the power management and charge controller sending at least one of a second power, voltage information, and current information to the fast charging battery until the fast charging battery has at least a first predetermined voltage;
c. the fast charging battery sending at least one of a third power, voltage information, and current information to the power management and charge controller and sending the third power to a step-up DC/DC converter;
d. converting the third power to a fourth power having a voltage of 5.0V via the step-up DC/DC converter;
e. sending the fourth power to the co-processor and one of the authentication chip and lightning connector module;
f. the co-processor and one of the authentication chip and lightning connector module sending at least one of the fourth power, voltage information, and current information to the mobile electronic device; and
g. the mobile electronic device sending at least one of the fourth power, voltage information, and current information to the co-processor and one of the authentication chip and the lightning connector module.

32. The method of claim 31, wherein the first power is received from the external power supply through a 3.5 mm diameter power jack.

33. The method of claim 31, wherein the power supply is one of a 12-24V DC power supply, an AC power supply, and a 5V DC power supply.

34. The method of claim 31, wherein the first predetermined voltage is 3.0V.

35. The method of claim 26, further comprising the steps of:
a. the lightning connector module receiving power from the mobile electronic device; and
b. sending an authentication number to the mobile electronic device.

36. The method of claim 31, further comprising the steps of:
a. the lightning connector module receiving power from the mobile electronic device; and
b. sending an authentication number to the mobile electronic device.
